(19) United States
(12) Patent Application Publication
(10) Pub. No.: US 2004/0008827 A1
(43) Pub. Date: Jan. 15, 2004

(54) Management of a voicemail system

(75) Inventors: David Gerard Martin, Eastleigh (GB); Peter John Johnson, Chandlers Ford (GB)

Correspondence Address: Jerry W. Herndon, IBM Corp, IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/318,259

(22) Filed: Dec. 12, 2002

(30) Foreign Application Priority Data
Jul. 11, 2002 (GB) 0216066.1

(51) Int. Cl. H04M 1/64; H04M 11/00

(52) U.S. Cl. 379/67.1; 379/88.13

(57) ABSTRACT

The present invention relates to a method for managing outgoing messages (OGMs) in a voicemail system. An OGM is accessed in visual format. The OGM in visual format is edited using a GUI. An edited OGM in audio format is then formed to correspond to the edited OGM in visual format.

### FIELD OF THE INVENTION

This invention relates to management of a voicemail system. In particular it relates to editing outgoing messages by a voicemail subscriber in a graphical environment.

### BACKGROUND OF THE INVENTION

In a voicemail system telephone callers may be answered by a computer system when a subscriber to the voicemail system is either unable or chooses not to receive a call, for instance, when the subscriber is on another call or not at the telephone. Callers are presented with an audio greeting known as an outgoing message (OGM). The OGM invites callers to record a voice message which is subsequently played back by the subscriber.

Voicemail systems enable subscribers to customise various aspects of their voicemail configuration including the OGM. The OGM is recorded by the subscriber and stored by the voicemail system. The contents of the OGM will vary by subscriber, though in the business environment it is not unusual for the OGM to include subscriber details, a brief explanation for the absence of a human call taker, and a period for which the OGM is valid. The subscriber configures the voicemail system to determine when an OGM is active (i.e. when callers will hear an OGM) and when it is inactive.

To ensure it is kept up to date and appropriate in different situations the OGM is replaced. For example, the OGM may be replaced each morning to provide callers with details relevant during the daytime, and replaced each evening to provide callers with details out of office hours. The different OGMs recorded in the morning may be similar, as may those recorded in the evening. It is therefore desirable to store multiple OGMs, such as a morning OGM and an evening OGM. U.S. Pat. No. 4,881,260 discloses a telephone answering device with multiple OGMs and selecting means. The telephone answering device comprises a recording medium having an OGM recording area which is divided into multiple OGM sections. Each OGM section has a start position and an end position and is used to record one of many OGMS. One OGM section is selected in order to record or play-back a specific OGM. This allows a specific OGM (e.g. a morning OGM) to be recorded in each of the multiple OGM sections of the recording medium. The a caller will be greeted by the OGM recorded in the selected section.

While the OGM required in the morning may be similar every day, it may not be identical. For instance, the morning OGM may include an introductory segment including context information such as a date. The remainder of the OGM may be identical every morning. Changes to the morning OGM will therefore involve only part of the message. Some voicemail systems allow an OGM to be divided into at least two segments with a header and a body. Context information (such as the date) may be contained in the header with fixed information (such as an invitation to record a voice message) contained in the body. These segments of an OGM can be defined separately and used together to form a complete OGM. Using a segmented OGM removes the need to replace an entire OGM when it is only necessary to update context information.

A voicemail system such as IBM Message Center running on IBM WebSphere Voice Response for AIX supports multiple OGMs where each OGM may be segmented. The use of multiple and segmented OGMs results in the need to verify outgoing messages for accuracy and to select a single OGM appropriate to a given situation. In order to manage a voicemail system, including recording, verifying and selecting OGMs and retrieving received voice messages, it is necessary for a subscriber to interact with the voicemail system through a user interface.

A voicemail management user interface may be provided over a telephone network such as a public switched telephone network. Voicemail systems whereby users interact over a telephone network with computerised equipment are known as telephony user interfaces (TUI) and are very well-known in the art. Typically such systems ask a user questions using voice prompts formed from one or more pre-recorded audio segments, and a user inputs answers by pressing dual tone multiple frequency (DTMF) keys on their telephone. OGMs and voice messages may be recorded and replayed as audio using such systems. In order to verify and select a recorded audio OGM using a TUI it is necessary to listen to the OGM. This is time consuming where there are many outgoing messages or where outgoing messages have a long duration. Also, the use of a TUI to manage outgoing messages may not be effective where a subscriber is at a remote location without access to a telephone, or without access to telephony services of sufficient quality to make acceptable recordings of outgoing messages.

### SUMMARY OF THE INVENTION

Accordingly, the present invention provides a method for managing OGMs in a voicemail system. In accordance with the method of the present invention an OGM is accessed by a subscriber to the voicemail system in visual format. The OGM in visual format is edited using a GUI. An OGM in audio format is then formed to correspond to the edited OGM in visual format. For example, the OGM may be accessed in text format allowing the subscriber to read and edit the content of the OGM as text using the GUI. An OGM in audio format is then formed corresponding to the edited OGM in text format.

In one embodiment, the method for managing OGMs in a voicemail system is initiated by the subscriber through a TUI. Once initiated, the subscriber manages the OGMs according to the method of the present invention using the GUI. This is advantageous when the subscriber is prompted to manage OGMs during interaction with the voicemail system through a TUI.

OGMs for a voicemail system may be recorded by the subscriber in audio format, for example through the use of a TUI. In this case, the method preferably provides for accessing the OGMs in audio format and converting the OGMs to text format using a speech recognition system allowing OGMs entered in audio format to be edited in visual format.

Preferably the method provides for forming an OGM in audio format to correspond to the edited OGM in visual format using a text to speech processor such as a speech synthesis system. This is advantageous when the OGMs are accessed in text format.

When editing the OGM in visual format, the method preferably provides for adding or removing content from the OGM or adding a new OGM or removing the OGM.

According to a second aspect of the present invention, a computer program product comprising computer program code stored on a computer readable storage medium, when executed on a computer, the program code embodied therein effects the method described above.

According to a third aspect of the present invention there is provided a means for managing OGMs in a voicemail system, comprising a means for accessing an OGM in visual format, a means for editing the visual OGM in a graphical user interface and a means for forming an audio format OGM to correspond to the edited visual OGM.

The present invention accesses voicemail OGMs in visual format such as text for editing as required. A subscriber is able to view and edit an OGM in visual format through a GUT allowing review and amendment of the OGM to take place more quickly and in a more user friendly manner.

Following the edit of OGMs in visual format a corresponding OGM in audio format is formed. This achieves a further advantage of allowing OGMs to be edited as text and converted to audio overcoming problems of audio recording quality where a user is without access to telephony services of sufficient quality to make acceptable recordings of OGMs.

### BRIEF DESCRIPTION OF THE DRAWINGS

A preferred embodiment of the invention will now be described in detail by way of example only with reference to the following drawings:

FIG. 1 illustrates an arrangement of a voicemail system;

FIG. 2 illustrates an arrangement of data in the data store of FIG. 1 in a first embodiment of the present invention;

FIG. 3 depicts the voicemail management GUT of FIG. 1 in a first embodiment of the present invention;

FIGS. 4a and 4b are flow charts illustrating a method to effect changes in the data store of FIG. 1 when the subscriber selects the “Submit” button of FIG. 3 in a first embodiment of the present invention;

FIG. 5 illustrates an arrangement of data in the data store of FIG. 1 in a second embodiment of the present invention;

FIG. 6 depicts the voicemail management GUI of FIG. 1 in a second embodiment of the present invention;

FIG. 7 depicts the voicemail management GUI of FIG. 1 when the subscriber selects the “Select Header” button of FIG. 6 in a second embodiment of the present invention.

FIGS. 8 is a flow chart illustrating a method to manage OGMs in a voicemail system.

### DETAILED DESCRIPTION OF THE PREFERRED EMBODIMENTS

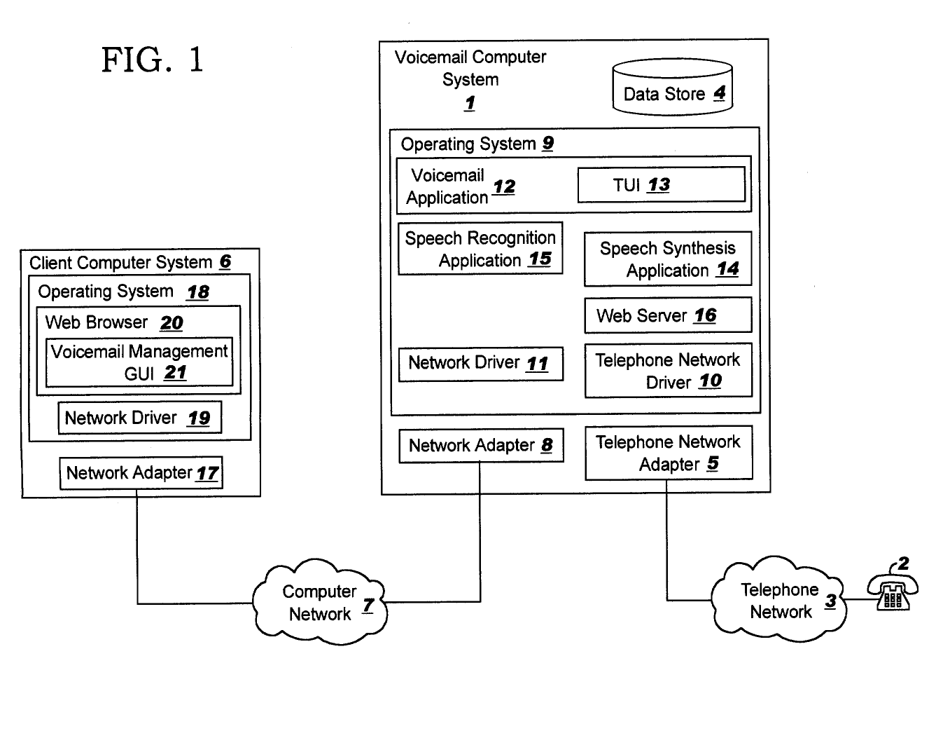

FIG. 1 illustrates an arrangement of a voicemail system. Voicemail computer system 1 is communicatively connected to telephone 2 across a telephone network 3 such as a public switched telephone network (PSTN). Voicemail computer system 1 includes a data store 4 such as a hard disk drive. Voicemail computer system 1 also includes a telephone network adapter 5 which co-ordinates the connection between the voicemail computer system 1 and the telephone network 3. In the preferred embodiment, the telephone network adapter 5 is a trunk interface card (TIC). The voicemail computer system 1 is also communicatively connected to a client computer system 6 via a computer network 7. In the preferred embodiment, the computer network 7 is the internet. Voicemail computer system 1 includes a computer network adapter 8 which co-ordinates the connection between the voicemail computer system 1 and the computer network 7. The computer network adapter 8 can be any suitable adapter for connecting a computer to a computer network such as an ethernet adapter.

In operation, the voicemail computer system 1 uses an operating system 9 such as IBM AIX. Operating system 9 includes telephone network driver 10 and computer network driver 11 components to control the telephone network adapter 5 and computer network adapter 8 respectively. Installed on the operating system 9 is a voicemail application 12 such as IBM Message Center running on IBM WebSphere Voice Response for AIX. The voicemail application 12 includes a TUI 13 which uses voice prompts and DTMF signals to allow a caller to configure the voicemail application and send and receive voice messages. Also installed on the operating system 9 is a speech synthesis application 14, a speech recognition application 15 and a web server 16. The speech synthesis application 14 converts text into synthesised voice data. The speech recognition application 15 converts audio speech data into text data with sufficient accuracy that the text data can be recognised as being a transcript of the audio speech data. The web server 16 provides web content including web pages to computers communicatively connected to voicemail computer system 1. Voicemail application 12 is accessible to web server 16 which can access and change the configuration of the voicemail application 12.

Client computer system 6 includes a computer network adapter 17 which co-ordinates the connection between the client computer system 6 and the computer network 7. The computer network adapter 17 can be any suitable adapter for connecting a computer to a computer network such as an ethernet adapter. In operation, the client computer system 6 uses an operating system 18 such as Microsoft Windows which includes computer network driver 19 component to control the computer network adapter 17. Installed on the operating system 18 is a web browser 20 communicatively connected to the web server 16 of voicemail system 1 across computer network 7. The web browser 20 receives web content from the web server 16. Web content displayed by the web browser 20 contains the voicemail management GUI 21.

A caller initiates a telephone call to a subscriber of the voicemail computer system 1 using the telephone 2. Subsequently, if the subscriber does not “answer” the callers telephone call, the voicemail system 1 plays an audio OGM to the caller across the telephone network 3. The content of the OGM played to the caller is determined by the subscriber who configures the voicemail computer system 1 using the voicemail management GUI 21 of client computer system 6.

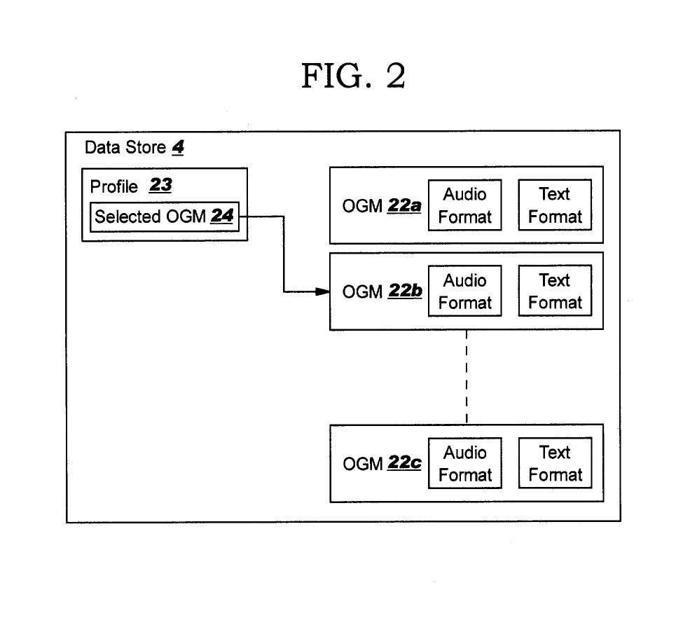

FIG. 2 illustrates an arrangement of data in the data store 4 for a first embodiment of the present invention. The subscriber of the voicemail computer system has associated one or more OGMs 22a, b and c stored in the data store 4. The OGMs 22a, b and c are stored in both text format and audio format. The OGMs 22a, b and c in audio format are stored as files in any of a variety of standard multimedia or audio formats such as Wave or MP3, containing audio signals representative of speech. OGMs 22a, b and c are created using the voicemail management GUI 21, or through the TUI 13 of voicemail computer system 1 accessed by telephone 2. Where an OGM is created using the TUI 13, the OGM is recorded in audio format over the telephone network 3 by the voicemail application 12. The speech recognition application 15 converts OGMs in audio format to text format for storage in the data store 4 (see FIG. 1). A profile 23 identifies one OGM as the selected OGM 24 for the subscriber. The subscriber is able to add, delete and edit OGMs 22a, b and c and specify the selected OGM 24 using the voicemail management GUI 21.

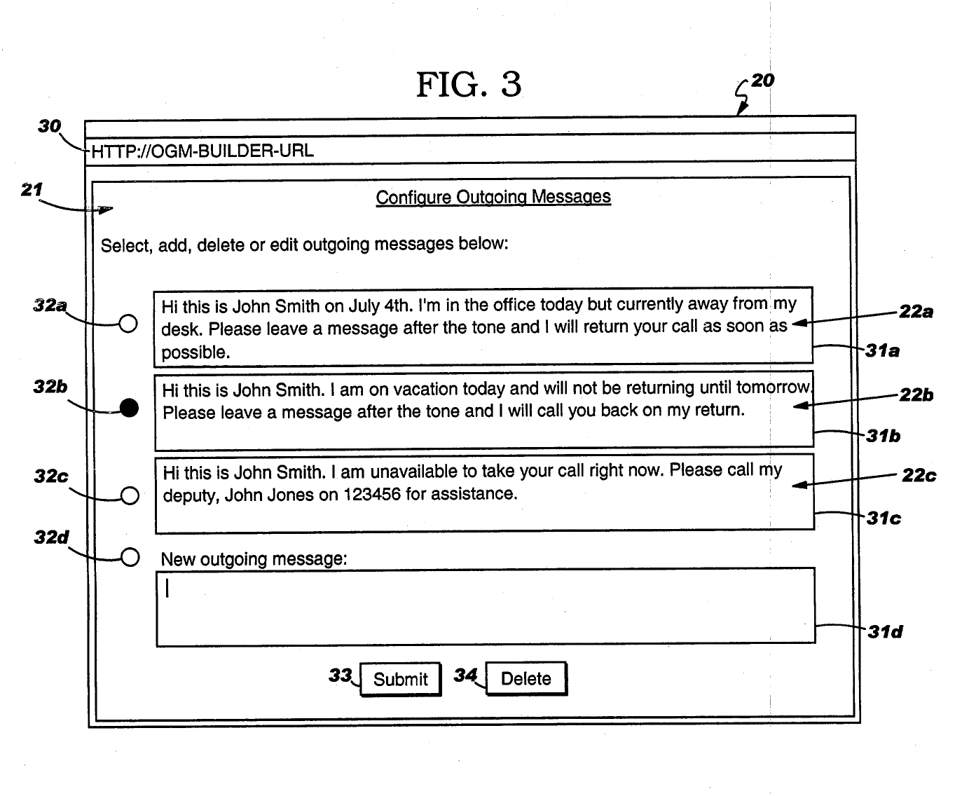

FIG. 3 depicts the voicemail management GUI 21 as it is viewed by the subscriber in web browser 20 in the first embodiment of the present invention. The subscriber directs web browser 20 to the web server 16 of voicemail computer system 1 using an uniform resource locator (URL) 30. The URL 30 uniquely identifies the voicemail management computer system 1 and the web content comprising the voicemail management GUI 21 on computer network 7. In the voicemail management GUI 21 OGMs 22a, b and c are displayed in text format in text edit fields 31a, b and c each with an associated radio button 32a, b and c respectively. The selected OGM 24 is indicated by the selected radio button 32b. The subscriber is able to change the selected OGM 24 by selecting an alternative radio button. The subscriber is also able to edit the text format of the OGMs 22a, b and c by changing the text in the text edit fields 31a, b and c, and add a new OGM by entering text into text edit field 31d and selecting radio button 32d. When the subscriber has made all required changes to the text edit fields 31a, b, c and d and the radio buttons 32 a, b, c and d, the “Submit” button 33 is selected to effect the changes in the data store 4 of voicemail computer system 1. Alternatively, the “delete” button 34 is selected to delete the OGM identified by the selected radio button from the data store 4.

The voicemail management GUI 21 is also initiated by the subscriber using the TUI 13 of voicemail application 12. The subscriber accesses the TUI 13 using telephone 2 across telephone network 3. The TUI 13 allows the subscriber to initiate the voicemail management GUI 21 by uniquely identifying client computer system 6 on computer network 7. In the preferred embodiment, client computer system 6 is identified using it's internet protocol (IP) address.

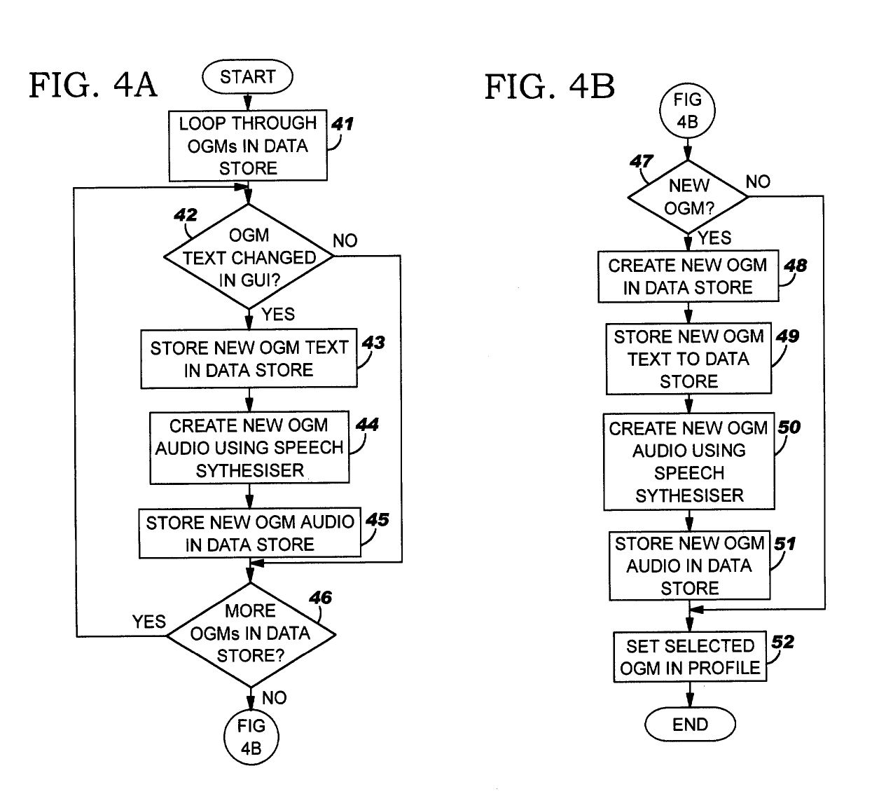

FIGS. 4a and 4b are flow charts illustrating a method to effect changes in the data store 4 of voicemail computer system 1 when the “Submit” button 33 of the voicemail management GUI 21 is selected. For each of the OGMs 22a, b and c steps 42, 43, 44, 45 and 46 determine if the OGM was updated in the voicemail management GUI 21, and if so, updates the OGM in the data store 4 accordingly. Steps 47 and 48 determine if a new OGM was entered in text edit field 31d of the voicemail management GUI 21, and if so adds the new OGM to the data store 4. Step 49 updates the selected OGM 24 in the profile 23 of data store 4. These steps are outlined in detail below.

Initially step 41 loops through each of the OGMs 22a, b and c in data store 4 and text edit fields 31a, b and c in the voicemail management GUI 21 respectively. For each of the OGMs 22a, b and c step 42 determines if the text format of the OGM in the data store 4 is different to the contents of the respective text edit field in the voicemail management GUI 21. If it is not different, the method proceeds to step 46. If it is different then the OGM text has been updated in the text edit field. Step 43 stores the contents of the text edit field in data store 4 replacing the existing text format of the OGM. Step 44 creates a new audio format of the OGM using speech synthesis application 14 of voicemail computer system 1 and the contents of the text edit field. Step 45 stores the new audio format of the OGM in data store 4 replacing the existing audio format of the OGM. Step 46 loops back to step 42 until each of OGMs 22a, b and c in data store 4 has been processed. On completion of the loop, step 47 determines if a new OGM was entered into text edit field 31d of voicemail management GUI 21. If a new OGM was not entered the method proceeds to step 52. If a new OGM was entered step 48 creates a new OGM in data store 4. Step 49 stores the contents of the text edit field 31d as the text format of the new OGM in data store 4. Step 50 creates an audio format of the new OGM using speech synthesis application 14 of voicemail computer system 1 and the contents of text edit field 31d. Step 51 stores the audio format of the new OGM in data store 4. Finally, step 52 updates the selected OGM 24 in profile 23 to reflect the OGM identified by the selected radio button 32a, b, c or d in the voicemail management GUI 21.

By way of example, the first embodiment of the present invention will now be described in use by the subscriber. The subscriber accesses the voicemail computer system 1 using telephone 2 across telephone network 3 in order to collect audio voice messages left by telephone callers. The subscriber interacts with the voicemail computer system 1 using the TUI 13 of voicemail application 12. In accessing the voicemail application 12 the subscriber is prompted to review and manage OGMs 22a, b and c. The subscriber uses the TUI 13 to initiate the voicemail management GUI 21 in web browser 20 of client computer system 6 accessible to the subscriber. The voicemail management GUI 21 displays OGMs 22a, b and c in text format in text edit fields 31a, b and c each with an associated radio button 32a, b and c respectively. Radio button 32b is selected indicating the selected OGM 24 played to callers is OGM 22b. The subscriber chooses to change the selected OGM 24 by choosing radio button 32c and selecting the “Submit” button 33. The voicemail application 12 processes the changes made by the subscriber in the voicemail management GUI 21 as illustrated in the flowchart in FIGS. 4a and 4b to change the selected OGM 24 in data store 4 to refer to OGM 22c. Subsequently a caller initiates a telephone call to a subscriber of the voicemail computer system 1 using the telephone 2. The subscriber does not “answer” the callers telephone call and the voicemail system 1 plays the audio format of OGM 22c to the caller across the telephone network 3.

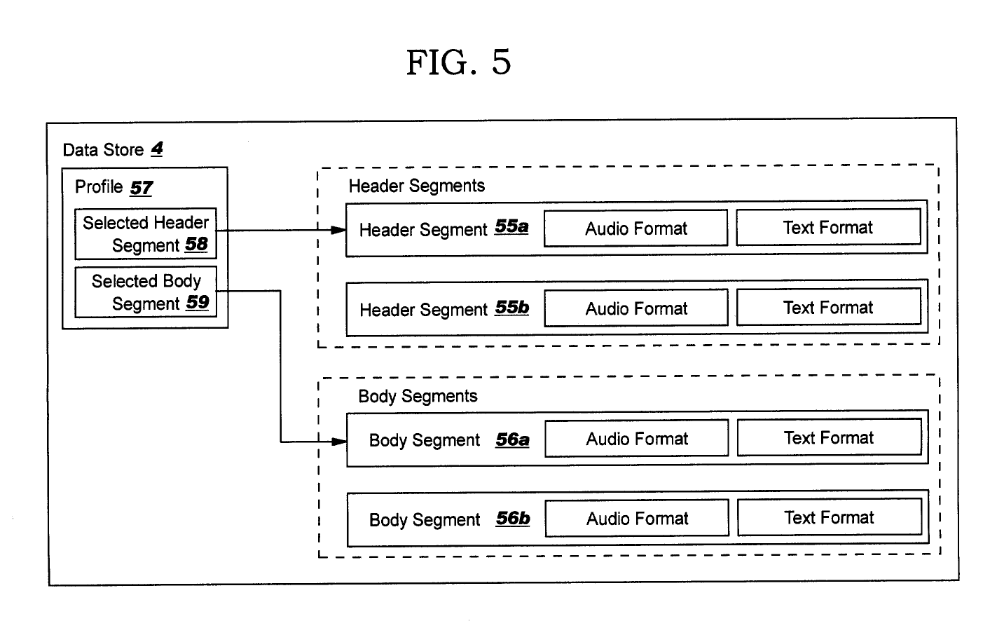

FIG. 5 illustrates an arrangement of data in the data store 4 for a second embodiment of the present invention. The subscriber of the voicemail system has associated one or more header segments 55a and b and one or more body segments 56a and b stored in the data store 4. The header segments 55a and 55b and body segments 56a and 56b represent segments of a voicemail OGM and are stored in both text format and digital audio format. The digital audio segments are stored as files in any of a variety of standard multimedia or audio formats such as Wave or MP3, containing audio signals representative of speech. Header segments 55a and 55b and body segments 56a and 56b are created using the voicemail management GUI 21, or through the TUI 13 of voicemail computer system 1 accessed by telephone 2. Where a segment is created using the TUI 13, the segment is recorded in audio format over the telephone network 3 by the voicemail application 12. The speech recognition application 15 converts audio format segments to text format for storage in the data store 4. A profile 57 identifies one header segment as the selected header segment 58, and one body segment as the selected body segment 59. The subscriber is able to change the selected header segment 58 and the selected body segment 59 using the voicemail management GUI 21. The subscriber is also able add, delete and edit header segments 55a and 55b and body segments 56a and 56b using the voicemail management GUI 21.

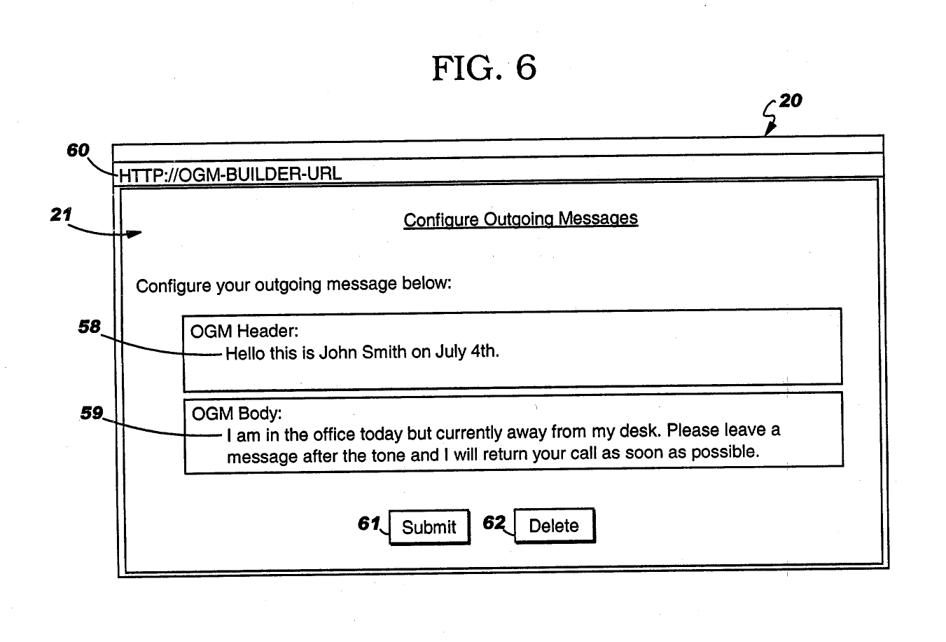

FIG. 6 depicts the voicemail management GUI 21 as it is viewed by the subscriber in web browser 20 in the second embodiment of the present invention. The subscriber directs web browser 20 to the web server 16 of voicemail computer system 1 using an uniform resource locator (URL) 60. The URL 60 uniquely identifies the voicemail management computer system 1 and the web content comprising the voicemail management GUI 21 on computer network 7. In the voicemail management GUI 21 the text format of the selected header segment 58 and the selected body segment 59 are displayed. The subscriber is able to change the selected header by choosing the “Select Header” button 61. The subscriber is also able to change the selected body by choosing the “Select Body” button 62.

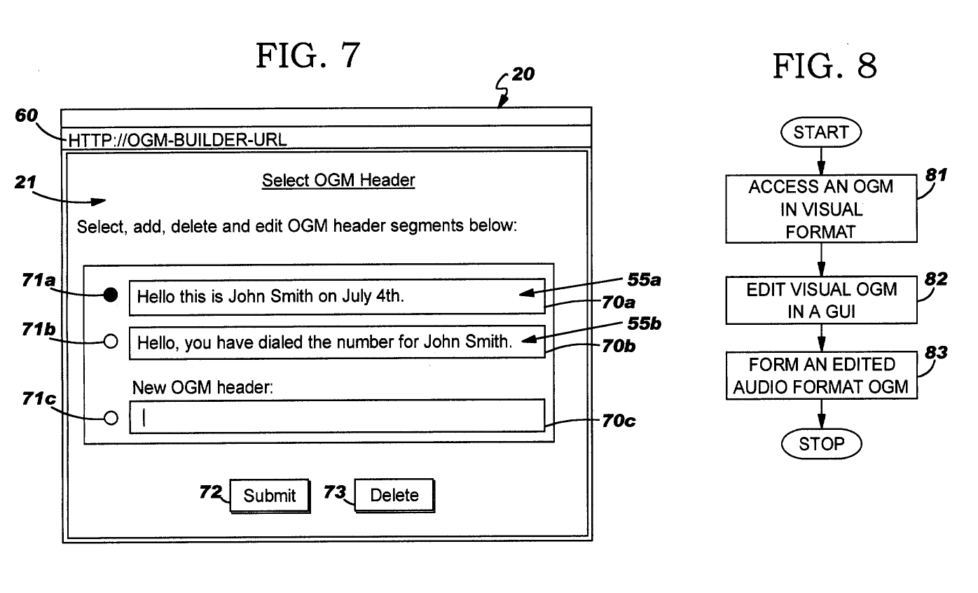

FIG. 7 depicts the voicemail management GUI 21 when the subscriber has chosen the “Select Header” button 61 of FIG. 6. In the voicemail management GUI 21 body segments 55a and 55b are displayed in text format in text edit fields 70a and 70b each with an associated radio button 71a and 71b respectively. The selected header segment 58 is indicated by the selected radio button 71a. The subscriber is able to change the selected header segment 58 by selecting an alternative radio button. The subscriber is also able to edit the text format of the header segments 55a and 55b by changing the text in the text edit fields 70a and 70b, and add a new header segment by entering text into text edit field 70c and selecting radio button 71c. When the subscriber has made all required changes to the text edit fields 70a, b and c and the radio buttons 71a, b and c the “Submit” button 72 is selected to effect the changes in the data store 4 of voicemail computer system 1. Alternatively, the “delete” button 73 is selected to delete the header segment identified by the selected radio button from the data store 4.

The method to effect changes in the data store 4 of voicemail computer system 1 when the “Submit” button 72 is pressed is identical to the method described in the first embodiment to effect changes in the data store 4 of voicemail computer system 1 and illustrated in FIGS. 4a and 4b except in that the second embodiment manages OGM segments where the first embodiment manages OGMs. Furthermore, the operation of the voicemail management GUI 21 for managing body segments 56a and 56b is identical to that described above and illustrated in FIG. 7 for header segments.

FIG. 8 is a flow chart illustrating a method to manage OGMs in a voicemail system. Initially step 81 accesses an OGM in a visual format such as text format. Accessing the OGM in visual format may involve accessing the OGM in audio format and converting the OGM to visual format using a speech recognition application 15. In step 82 the OGM is edited in visual format by the subscriber using the voicemail management GUI 21. Step 83 subsequently forms an audio format OGM corresponding to the edited visual format OGM.

1. A method for managing outgoing messages (OGMs) in a voicemail system characterised by:
accessing an OGM in visual format;
editing said visual OGM in a graphical user interface; and
forming an audio format OGM to correspond to said edited visual OGM.

2. The method of claim 1 wherein said method is initiated by a subscriber to said voicemail system through a telephony user interface (TUI).

3. The method of claim 1 wherein said accessing step is further characterised by:
accessing an OGM in audio format;
converting said OGM to visual format using a speech recognition system.

4. The method of claim 1 wherein said accessing step is further characterised by adding a new OGM in visual format.

5. The method of claim 1 wherein said forming step is further characterised by converting said edited visual OGM to audio format using a speech synthesis system.

6. The method of claim 1 wherein said editing step is further characterised by adding or removing content from said OGM.

7. The method of claim 1 wherein said editing step is further characterised by removing said OGM.

8. A computer program product comprising instructions which, when executed on a data processing system having a non-volatile memory storage device, causes said system to carry out a method as claimed in any one of claim 1 to claim 7.

9. A means for managing outgoing messages (OGMs) in a voicemail system characterised by:
a means for accessing an OGM in visual format;
a means for editing the visual OGM in a graphical user interface; and
a means for forming an audio format OGM to correspond to the edited visual OGM.

10. The means of claim 9 wherein said accessing means is further characterised by:
a means for accessing an OGM in audio format;
a means for converting said OGM to visual format using a speech recognition system.

11. The means of claim 9 wherein said accessing means is further characterised by a means for adding a new OGM in visual format.

12. The means of claim 9 wherein said forming means is further characterised by a means for converting said edited visual OGM to audio format comprising a speech synthesis system.

13. The means of claim 9 wherein said editing means is further characterised by a means for adding or removing content from said OGM.

14. The means of claim 9 wherein said editing means is further characterised by a means for removing said OGM.
